(19) United States
(12) Patent Application Publication
(10) Pub. No.: US 2002/0148829 A1
(43) Pub. Date: Oct. 17, 2002

(54) Induction furnace for heating granules

(76) Inventor: Oleg S. Fishman, Maple Glen, PA (US)

Correspondence Address: PHILIP O. POST, INDUCTOTHERM INDUSTRIES, INC., PO BOX 157, RANCOCAS, NJ, 08073, US

(21) Appl. No.: 10/047,646

(22) Filed: Jan. 15, 2002

Related U.S. Application Data
(60) Provisional application No. 60/262,011, filed on Jan. 17, 2001.

(51) Int. Cl. H05B 6/06

(52) U.S. Cl. 219/656; 219/652

(57) ABSTRACT

Apparatus and method is provided for the heating of granules by the use of induction power. A rotating furnace chamber is provided with interior conveying elements that transport granules through the furnace. The furnace body, or alternatively, a susceptor surrounding the furnace body is inductively heated. Heat is transferred by conduction from the furnace body or susceptor to the granules traversing the furnace chamber. Multiple induction coils and switching arrangements can be used to provide varying degrees of heat along the length of the furnace chamber.

### CROSS REFERENCE TO RELATED APPLICATIONS

This application claims the benefit of U.S. Provisional Application No. 60/262,011, filed Jan. 17, 2001.

### FIELD OF THE INVENTION

The present invention generally relates to the heating of granules and more particularly to heating granules as they travel through the interior of a rotating furnace by transfer of magnetically induced heat in the material of the furnace or a separate susceptor.

### BACKGROUND OF THE INVENTION

Granules encompass a broad range of particulate materials that include powders of varying grades, and may exhibit magnetic or non-magnetic properties. Ferromagnetic powders, such as a steel powder, can be used to form an article in any shape by the application of high temperature and pressure to the powder in a mold. The metallurgical properties of the powder will effect how well the article is formed. In general, a “soft” textured powder is desirable for forming the article.

A conventional method of forming a metal powder is by passing a chilled air or water stream across a flow of molten metal. The chilled fluid freezes the metal into granules of powdered metal. The process produces a metallurgically hard powder that would be very difficult to compress into a finished form. To soften the powder, as illustrated in FIG. 1, the powder 100 is transferred by feeder 112 to a fine-mesh steel conveyor belt 114 that transports the metal powder through a tunnel furnace 116. Gas or electric radiant tube heaters 118 radiate heat in the furnace to heat the powder being conveyed through the firnace. The furnace heats the powder and produces a soft, annealed metal powder. The conventional furnace has a tendency to unevenly heat the granules of metal powder and the gas or electric radiant heat source is a relatively inefficient method of heating the powder.

Therefore, there exists the need for apparatus and a method that will efficiently and more evenly heat granules of a material.

### BRIEF SUMMARY OF THE INVENTION

In one aspect the present invention is an apparatus and a method for heating granules by application of induction power to a rotating furnace body that uses internal conveying means to move the granules through the furnace chamber. These and other aspects of the invention are set forth in the specification and claims.

### BRIEF DESCRIPTION OF THE DRAWINGS

For the purpose of illustrating the invention, there is shown in the drawings a form which is presently preferred; it being understood, however, that this invention is not limited to the precise arrangements and instrumentalities shown.

FIG. 1 is a cross sectional view of a conventional prior art tunnel furnace that is used to heat granules.

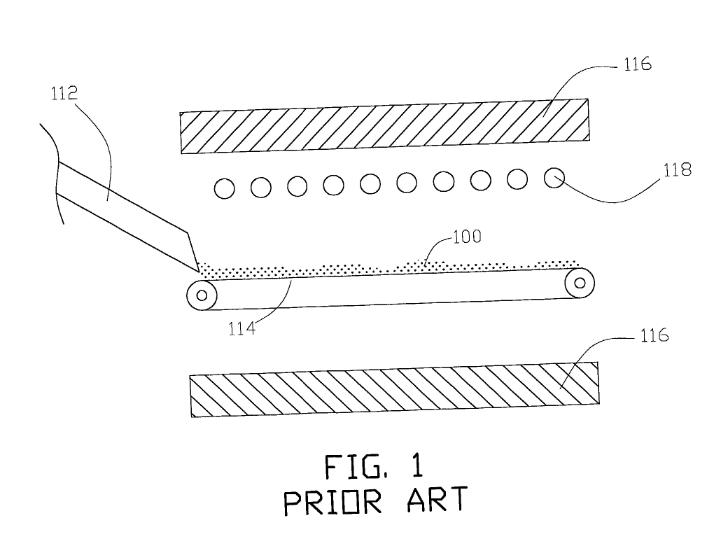

FIG. 2 is a cross sectional view of one example of the furnace of the present invention for heating granules.

FIG. 3 is a cross sectional view of another example of the furnace of the present invention for heating granules.

FIG. 4 is a cross sectional view of another example of the furnace of the present invention for heating granules.

### DETAILED DESCRIPTION OF THE INVENTION

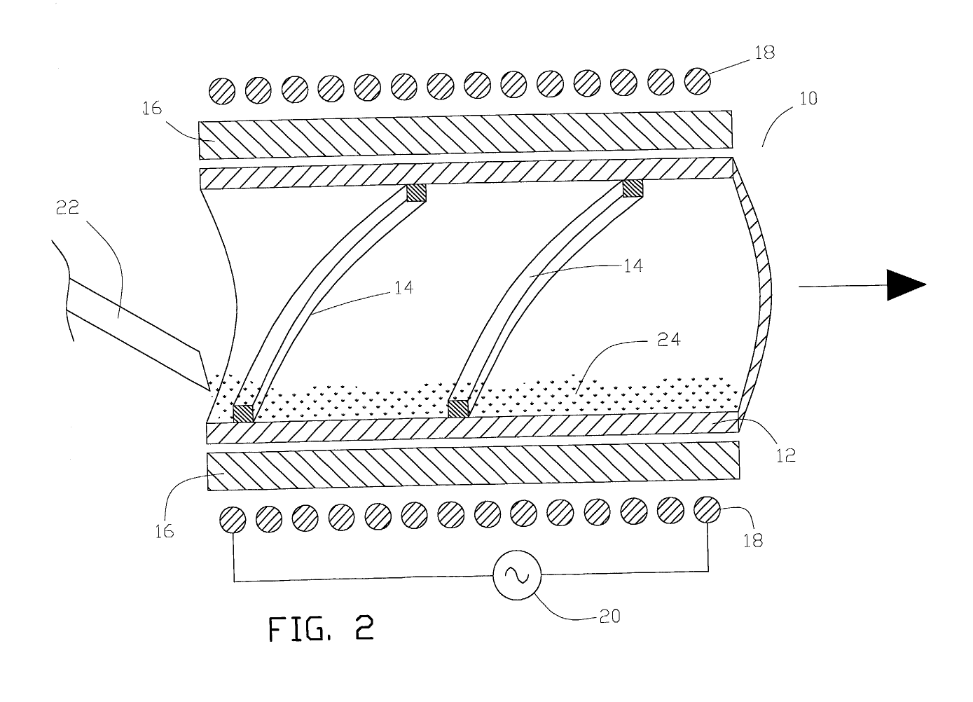

There is shown in FIG. 2 a first example of the induction furnace 10 of the present invention for heating granules. Granules include a range of particles, including what are known as powders used in powder metallurgical processes. In these processes, metal powders, or granules, after heating by the apparatus and method of the present invention, are compacted in a die to a desired shape, and then sintered or heated in a furnace to produce an article. Furnace body 12 is formed substantially from a suitable electrically conductive material. For some applications, a ferromagnetic material, such as steel, can be used. As shown in this example of the invention, the furnace body is generally cylindrical in shape and forms a tubular structure. Variants of this configuration are suitable for use of the invention, provided that the configuration allows advancing of the granules through the furnace by conveying element 14 as the furnace rotates. The interior passage of the tubular structure forms the heating chamber. Conveying element 14 is inserted inside of the interior passage. The function of the conveying element is to advance the granules 24 through the furnace in the direction of the arrow as the furnace is rotated. Rotation is generally about the longitudinal axis of the furnace chamber, but off-axis, for example, ellipsoidal rather than circular rotation is contemplated within the scope of the invention. Conveying element 14 can be a continuous and screened helical structure that runs the length of the furnace chamber, but other structures are contemplated as being within the scope of the invention, so long as the conveying element functions to advance the granules through the furnace. For example, conveying element 14 may consist of a series of discrete elements rising from the interior wall of the chamber arranged in a manner to advance the granules through the furnace. Conveying element 14 is formed from a suitable high temperature material, such as steel, and may be inserted and fastened to the wall of the interior passage, or fabricated as an integral feature of the furnace chamber. In this example of the invention, suitable thermal insulating material, or refractory material 16, such as a silicon composition, surrounds furnace body 12 and serves to retain heat within the furnace body and to electrically isolate the furnace body from induction coil 18. Induction coil 18 surrounds the outer wall of the furnace body and the refractory material. The coil is suitably connected to ac power source 20. Current supplied from the power source flows through the coil and produces a magnetic field that induces eddy current heating in the electrically conductive material that comprises the furnace body.

In operation, feeding element 22 delivers granules 24 into the furnace chamber. Furnace body 12 is rotated by conventional rotational drive means (not shown in the figures) at a relatively slow rate that is determined by the length of the furnace chamber and desired degree of heat “soaking” of the granules at the temperature inside of the chamber. As the furnace body rotates, granules are advanced through the furnace by helical conveying element 14. Preferably, the height of granules along the length of the furnace is approximately equal to the height of the screened conveying element so that the granules are sifted and remain loosely packed as they travel through the furnace to achieve a uniform heating effect. Inductive heating is controlled by a conventional temperature feedback circuit in the chamber to maintain a chamber temperature that, in some application, can be limited up to the Curie point of the granules.

Further, the output of the power supply and the thickness of the furnace body are selected to maximize the depth of current penetration into the furnace body. The depth of current penetration into the furnace body, Δ_{m,} is defined (in meters) by the following equation:

$${Δ}_{M} = \sqrt{\frac{2 \cdot {ρ}_{m}}{{μ}_{O} \cdot {μ}_{m} \cdot f}} = 503 \sqrt{\frac{{ρ}_{m}}{f}}$$

where

ρₘ=resistivity of the molten metal (in ohms/m);

μₒ·μₘ the product of absolute and relative permeability,

with μₒ4π×10⁻⁷ H/m, and μₘ, the relative permeability of the furnace body, is in H/m; and

f=the frequency of the induction coil current (in Hertz), which is controlled by the output of the power supply.

Maximizing the depth of current penetration into the furnace body assures high resistance of the furnace body and, therefore, higher electrical efficiency of the heating process.

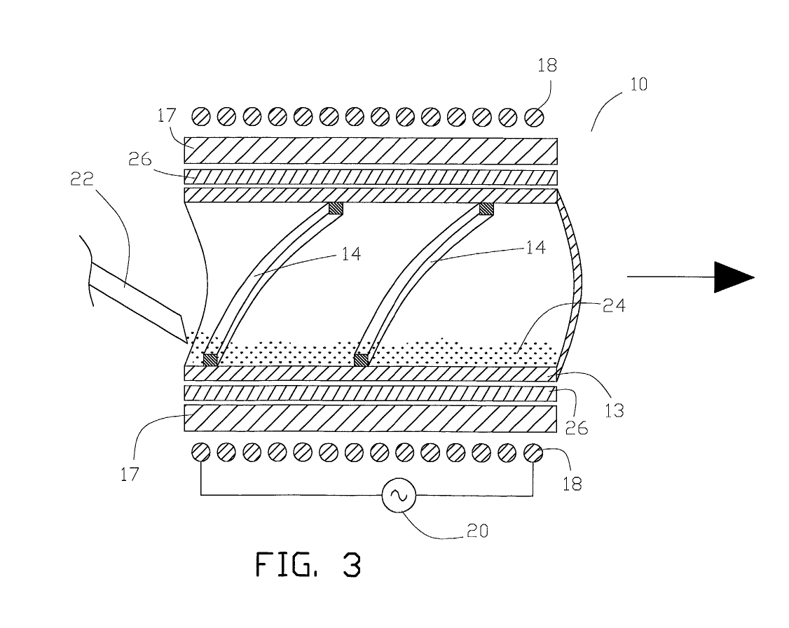

A second example of the invention is shown in FIG. 3. This embodiment is of particular value in heating granules to temperatures that are higher than the Curie point of the granules. An electrically conductor material 26, or susceptor, is placed around a furnace body 13 composed of a high temperature material, such as stainless steel. The susceptor may be attached to or separated from the exterior of the furnace body. If separated from the furnace body, the susceptor may or may not rotate with the furnace body. Suitable, but not limiting, susceptor materials are graphite and silicon carbide. In this embodiment, the magnetic field created by current flowing in induction coil 18 inductively heats the susceptor to temperatures above the Curie point of the granules 24. Heat generated in the susceptor by the induced eddy current conducts through furnace body 13 and is transferred to the granules 24 traveling through the interior of the furnace chamber in a similar fashion as that in the first example of the invention. Similar to the first example of the invention, thermal insulating material 17 can be placed around the exterior of the susceptor to assist in furnace retention of the inductively generated heat.

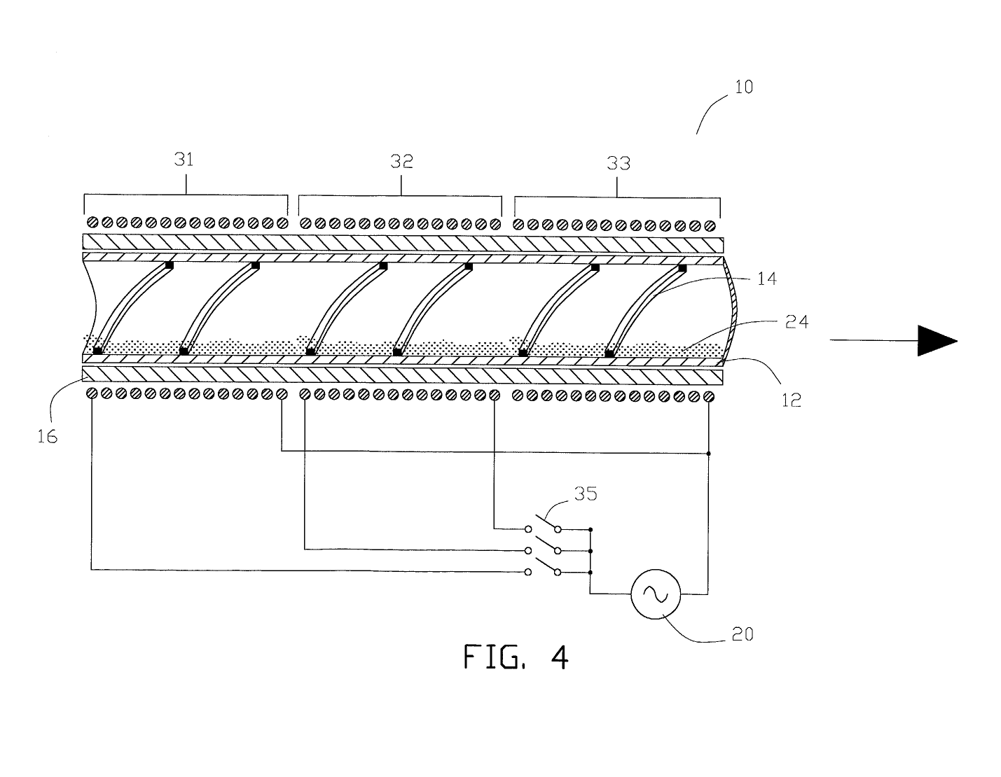

Another example of the invention is illustrated in FIG. 4. In this embodiment, three induction coils 31, 32, and 33 (any combination of two or more induction coils can be used) are selectively connected to ac power source 20 by switching means 35, which can be any suitable power switching elements, such as solid state switching devices. In this example, different temperatures can be maintained throughout the length of the furnace chamber by applying varying amounts of inductive power to each of the three induction coils to heat the granules to different temperatures as they travel through the furnace chamber in a similar fashion as that in the first example of the invention. Suitable alternative induction coil winding and switching schemes are disclosed in U.S. Pat. No. 6,121,592, entitled Induction Heating Device and Process for the Controlled Heating of a Non-electrically Conductive Material, which is incorporated herein in its entirety. The selective switching of multiple coils in this example of the invention can also be applied to the above second example of the invention wherein the single induction coil 18 in FIG. 3 is replaced by two or more induction coils connected to suitable switching means.

The foregoing embodiments do not limit the scope of the disclosed invention. The scope of the disclosed invention is further set forth in the appended claims.

1. An induction furnace for heating a plurality of granules comprising:
a furnace chamber comprising an electrically magnetic material;
an at least one conveying element to advance the plurality of granules through the furnace chamber when the furnace chamber is rotated, the at least one conveying element attached to the interior of the furnace chamber;
a one or more induction coils disposed around the exterior of the furnace chamber;
a power supply having an output connecting to the one or more induction coils to supply an ac current through the one or more induction coils; and
means for feeding the plurality of granules into the entry of the interior of the furnace chamber;
whereby when the furnace chamber is rotated the plurality of granules are advanced through the interior of the furnace chamber while being heated from heat generated in the furnace chamber by inductive coupling of the furnace chamber with a magnetic field created when the ac current is supplied through the one or more induction coils.

2. The induction furnace of claim 1 further comprising a thermal insulating material disposed between the exterior of the furnace chamber and the one or more induction coils.

3. The induction furnace of claim 1 wherein the one or more induction coils comprises an at least two induction coils, and the induction furnace further comprises a switching means connected between each of the at least two induction coils and the output of the power supply, the switching means selectively connecting each of the at least two induction coils to the output of the power supply to vary the heat generated along the axial length of the furnace chamber.

4. The induction furnace of claim 1 wherein the electrically conductive material comprises a ferromagnetic material.

5. The induction furnace of claim 1 wherein the at least one conveying element comprises a helically shaped structure protruding from the inner wall of the furnace chamber for the length of the furnace.

6. The induction furnace of claim 1 wherein the at least one conveying element comprises a plurality of discrete elements protruding from the inner wall of the furnace chamber.

7. An induction furnace for heating a plurality of granules comprising:
a furnace chamber;
an at least one conveying element to advance the plurality of granules through the furnace chamber when the furnace chamber is rotated about its axial length, the at least one conveying element attached to the interior of the furnace chamber;
an electrically conductive material disposed around the exterior of the furnace chamber;
a one or more induction coils disposed around the exterior of the electrically conductive material;
a power supply having an output connecting to the one or more induction coils to supply an ac current through the one or more induction coils; and
means for feeding the plurality of granules into the entry of the interior of the furnace chamber;
whereby when the furnace chamber is rotated the plurality of granules are advanced through the interior of the furnace chamber while being heated from heat generated in the electrically conductive material by inductive coupling of the electrically conductive material with a magnetic field created when the ac current is supplied through the one or more induction coils.

8. The induction furnace of claim 7 further comprising a thermally insulative material disposed between the exterior of the electrically conductive material and the one or more induction coils.

9. The induction furnace of claim 7 wherein the one or more induction coils comprises an at least two induction, and the induction furnace further comprises a switching means connected between each of the at least two induction coils and the output of the power supply, the switching means selectively connecting each of the at least two induction coils to the output of the power supply to vary the heat generated along the axial length of the electrically conductive material.

10. The induction furnace of claim 7 wherein the at least one conveying element comprises a helically shaped structure protruding from the inner wall of the furnace chamber for the length of the furnace.

11. The induction furnace of claim 7 wherein the at least one conveying element comprises a plurality of discrete elements protruding from the inner wall of the furnace chamber.

12. A method of heating a plurality of granules comprising the steps of:
rotating an electrically conductive furnace chamber having a one or more conveying elements attached to the interior of the furnace chamber;
magnetically coupling a magnetic field with the electrically conductive furnace chamber to inductively heat the furnace chamber, the magnetic field generated by an ac current in a one or more induction coils disposed around the exterior of the furnace chamber;
feeding the plurality of granules into the interior of the furnace chamber; and
advancing the plurality of granules through the furnace chamber by the one or more conveying elements to heat the plurality of granules with heat conducted from the inductively heated furnace chamber.

13. The method of claim 12 wherein the step of rotating the electrically conductive furnace chamber is performed about an axis of rotation other than longitudinal axis of the furnace chamber.

14. The method of claim 12 further comprising the step of thermally insulating the exterior of the furnace chamber to retain heat within the furnace chamber.

15. The method of claim 12 further comprising the steps of providing an at least two induction coils for the one or more induction coils and selectively switching the ac current to each of the at least two induction coils to inductively heat the furnace chamber to varying temperatures along the axial length of the furnace chamber.

16. A method of heating a plurality of granules comprising the steps of:
rotating a furnace chamber having a one or more conveying elements attached to the interior of the furnace chamber;
surrounding the exterior of the furnace chamber with an electrically conductive material;
magnetically coupling a magnetic field with the electrically conductive material to inductively heat the electrically conductive material; the magnetic field generated by an ac current in a one or more induction coils disposed around the exterior of the furnace chamber;
feeding the plurality of granules into the interior of the furnace chamber; and
advancing the plurality of granules through the furnace chamber by the one or more conveying elements to heat the plurality of granules with heat conducted from the inductively heated electrically conductive material.

17. The method of claim 16 wherein the electrically conductive material comprises graphite or silicon carbide.

18. The method of claim 16 further comprising the step of rotating the electrically conductive material around the longitudinal axis of the furnace chamber.

19. The method of claim 16 further comprising the step of disposing a thermal insulating material between the exterior of the electrically conductive material to retain the inductively generated heat within the furnace chamber.

20. The method of claim 16 further comprising the steps of providing an at least two induction coils for the one or more induction coils and selectively switching the ac current to each of the at least two induction coils to vary the heat generated along the length of the electrically conductive material.
